(19) United States
(12) Patent Application Publication
(10) Pub. No.: US 2017/0059284 A1
(43) Pub. Date: Mar. 2, 2017

(54) NETWORK SMART DART COMPETITION SYSTEM AND NETWORK DART COMPETITION METHOD

(71) Applicant: The Darts Factory Limited, Chaiwan (HK)

(72) Inventor: Jennifer TSUI, Hong Kong (CN)

(21) Appl. No.: 15/144,640

(22) Filed: May 2, 2016

(30) Foreign Application Priority Data
Aug. 28, 2015 (CN) 201510537794.X

(51) Int. Cl. F41J 5/04; G08B 5/36

(52) U.S. Cl. CPC F41J 5/04; G08B 5/36

(57) ABSTRACT

A network dart competition system is provided. In one example, the network competition system includes a first dart target configured to receive one or more darts from a first user; and a first receiving and analyzing device communicatively connected to the first dart target. The network competition system further includes a second dart target configured to receive one or more darts from a second user; and a second receiving and analyzing device communicatively connected to the second dart target. The first receiving and analyzing device and the second receiving and analyzing device communicate via a network to enable a dart competition between the first user and the second user.

### CROSS-REFERENCE TO RELATED APPLICATIONS

This Application claims the benefit of Chinese Application No. 201510537794.X, filed on Aug. 28, 2015, entitled NETWORK SMART DART COMPETITION SYSTEM AND NETWORK COMPETITION METHOD, which is hereby incorporated by reference in its entirety for all purposes.

### TECHNICAL FIELD

The present disclosure generally relates to the field of dart technologies, and in particular relates to a network dart competition system and a network dart competition method.

### BACKGROUND

A dart game integrates competition, fitness and entertainment, and becomes very popular today. It is mainly played in the way that players throw darts onto dart targets and compete against each other according to scores on the dart targets.

However, conventional dart targets have only single function and are not smart. Players that compete against each other can only play games at the same physical location. Since players in different regions are not connected, comparison and exchanging of skills among dart players may be unavailable. Conventional dart games using conversional dart targets may thus not be favorable for promotion and widespread of the sport of darts.

In light of this, there is a need to provide a network dart competition system and a network dart competition method. By improving the dart target and using a network system, the method may advance a relatively simple single-machine dart game to a broader network platform, and facilitate exchange and comparison of darting skills among players in different regions, such that the dart game becomes more challenging, more interesting, and more entertaining.

### SUMMARY

Systems and methods for network dart competition are provided. In accordance with one or more examples, a network dart competition system includes a first dart target configured to receive one or more darts from a first user; and a first receiving and analyzing device communicatively connected to the first dart target. The network dart competition system further includes a second dart target configured to receive one or more darts from a second user; and a second receiving and analyzing device communicatively connected to the second dart target. The first receiving and analyzing device and the second receiving and analyzing device communicate via a network to enable a dart competition between the first user and the second user.

In accordance with one or more examples, a method for network dart competition is provided. The method is performed at a first dart target including one or more processors, and includes detecting the receiving of a dart at the first dart target. In response to detecting the receiving of a dart, the method further includes generating an interrupt signal. In accordance with the interrupt signal, the method further includes determining a dart landing region indicating where the dart is received at the first dart target; and transmitting a signal representing a position of the dart landing region to a receiving and analyzing device associated with the first dart target.

In accordance with one or more examples, a method for network dart competition is provided. The method is performed at a first receiving and analyzing device including one or more processors, and includes receiving a signal representing a position of a dart landing region associated with a first dart target; and determining a first score based on the signal representing the position of the dart landing region associated with the first dart target. The method further includes transmitting a signal representing the first score to a second receiving and analyzing device.

In accordance with one or more examples, a non-transitory computer-readable storage medium is provided for performing a method for network dart competition. The non-transitory computer-readable storage medium includes one or more programs for execution by one or more processors of an electronic device. The one or more programs include instructions which, when executed by the one or more processors, cause the electronic device to perform the method of receiving a signal representing a position of a dart landing region associated with a first dart target; determining a first score based on the signal representing the position of the dart landing region associated with the first dart target; and transmitting a signal representing the first score to a second receiving and analyzing device.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1 is a schematic diagram illustrating a system and environment for implementing network dart competition according to various examples.

FIG. 2 is a block diagram illustrating a receiving and analyzing device, a user dart target, and a network server according to various examples.

FIG. 3 illustrates a flow diagram of an exemplary network dart competition method according to various examples.

### DETAILED DESCRIPTION

In the following description of the disclosure and embodiments, reference is made to the accompanying drawings, in which it is shown by way of illustration, of specific embodiments that can be practiced. It is to be understood that other embodiments and examples can be practiced and changes can be made without departing from the scope of the disclosure.

One of the objects of the present disclosure is to provide a network dart competition system, which can, by improving the dart target and using a network system, advance a relatively simple single-machine dart game to a broader network platform, and facilitate exchange and comparison of darting skills among users (e.g., dart players) in different regions or physical locations, such that the dart game becomes more challenging, more interesting, and more entertaining.

Although the following description uses terms “first,” “second,” etc. to describe various elements, these elements should not be limited by the terms. These terms are only used to distinguish one element from another. For example, a first dart target could be termed a second dart target, and, similarly, a second dart target could be termed a first dart target, without departing from the scope of the various described examples. The first dart target and the second dart target can both be dart targets and, in some cases, can be separate and different dart targets.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

To attain the aforementioned objects, the present disclosure provides the following exemplary technical solution.

In some embodiments, a network dart competition system is provided. The network dart competition system can include one or more of: a network server, one or more dart targets, and receiving and analyzing devices. The dart targets can include a first dart target (e.g., a player dart target) and a second dart target (e.g., an opponent dart target). The receiving and analyzing devices can include a first receiving and analyzing device (e.g., a player receiving and analyzing device) and a second receiving and analyzing device (e.g., an opponent receiving and analyzing device). In some examples, one or both the first receiving and analyzing device and the second receiving and analyzing device communicate with the network server. In some examples, the first and second receiving and analyzing device can communicate with each other without a network server (e.g., via an local area network, a Wi-Fi hotspot, or a Bluetooth connection). In some examples, the first dart target communicates with the first receiving and analyzing device, and the second dart target communicates with the second receiving and analyzing device.

In some embodiments of a network dart competition system according to the present disclosure, each of the first (e.g., player) dart target and the second (e.g., opponent) dart target can be provided with at least one of: one or more LED lights and a controller (e.g., a control chip). The controller can be electrically coupled to the LED lights. In some embodiments, the controller includes a first communication circuit that facilitates data transmission between the controller and the receiving and analyzing device. The controller further includes a sensor that can generate an interrupt signal when a dart is received (e.g., hits) a dart target. The sensor can transmit the interrupt signal to a first control circuit. The controller can further include the first control circuit, which can receive the interrupt signal transmitted from the sensor and control actions of a scanner. In some embodiments, the controller can further include a second control circuit that can receive a signal transmitted from the network server and control switching of the LED lights. The controller can further include a scanner that can, in accordance with the interrupt signal received by the first control circuit, determine (e.g., scan) a dart landing region where a dart is received at a dart target, and transmit the position of the dart landing region to the receiving and analyzing device via a wired or wireless connection (e.g., a Bluetooth connection enabled by a Bluetooth interface). In some embodiments, such transmission is facilitated by a first communication circuit.

In some embodiments, a network dart competition system according to the present disclosure includes a first (e.g., player) receiving and analyzing device and a second (e.g., opponent) receiving and analyzing device. One or both of the first receiving and analyzing device and the second receiving and analyzing device can include a second communication circuit. The second communication circuit can facilitate data transmission between the receiving and analyzing device and the network server. One or both of the first (e.g., player) receiving and analyzing device and the second (e.g., opponent) receiving and analyzing device can also include a signal receiver, a data analyzer, and/or a signal transmitter. In some examples, a signal receiver can receive a signal provided by the controller (e.g., a signal representing a position of a dart landing region) and transmit the signal to a data analyzer. A data analyzer can determine (e.g., calculate) a score based on the signal representing the position of the dart landing region. A signal transmitter can transmit a signal representing the score obtained by the data analyzer to the opposing receiving and analyzing device. For example, a signal transmitter of a first receiving and analyzing device can transmit a signal representing the score to a second receiving and analyzing device. In some embodiments, the signal transmitter first transmits the signal representing the score to a network server; and the network server then transmits the score to the opposing receiving and analyzing device.

In some embodiments, a network dart competition system according to the present disclosure includes a network server. The network server can include, for example, a data receiver, a data storage, and/or a data transmitter. In some examples, a data receiver can receive data from dart targets and/or receiving and analyzing devices. A data storage can store information received from the data receiver. And a data transmitter can transmit data to dart targets and/or receiving and analyzing devices.

In some embodiments, the network server may further include a comparator. The comparator can rank games and/or user (e.g., players). The data transmitter of the network server can further transmit the ranking information to receiving and analyzing devices.

In some embodiments, a network dart competition system according to the present disclosure can include a dart target that has subzones. Subzones of the dart target may be provided with antennas on the back of the subzones. In some examples, the antennas are disposed above the controller associated with the dart target. Further, in some examples, each of the subzones may correspond to one sensor. And if the antenna is in contact with the controller, the sensor corresponding to the subzone can generate an interrupt signal. In some examples, each of the subzones of a dart target can correspond to at least one LED light.

In some embodiments, the controller of a network dart competition system according to the present disclosure can further include a counter. The counter can be electrically connected to the sensor. In some embodiments, the counter may be further connected to a NEXT button, which may be disposed on the dart target.

In some embodiments, in a network dart competition system according to the present disclosure, each of the first (e.g., player) receiving and analyzing device and the second (e.g., opponent) receiving and analyzing device may further comprise a display. In some examples, the display of a receiving and analyzing device can display at least one of a connection status (e.g., Bluetooth connection status), a power condition, an indication whether one or more subzones associated with the corresponding dart target are interfered (e.g., whether a subzone is long pressed by a foreign object, or whether more than one subzones are pressed simultaneously). In some examples, the display can be further provided with a NEXT button.

In some embodiments, a receiving and analyzing device (e.g., a player or an opponent receiving and analyzing device) can further include a score accumulator. In some examples, the score accumulator is communicatively connected to the signal transmitter.

In some examples, the receiving and analyzing device can include at least one of a smart phone, a tablet computer, a laptop computer, a desktop computer, or a digital TV.

In some examples, the network dart competition system of the present disclosure can include one or more of: a network server, dart targets, and receiving and analyzing devices. The dart targets include a player dart target and an opponent dart target. The receiving and analyzing devices may include a player receiving and analyzing device and an opponent receiving and analyzing device. Both the player receiving and analyzing device and the opponent receiving and analyzing device can communicate with the network server. The player dart target communicates with the player receiving and analyzing device, and the opponent dart target communicates with the opponent receiving and analyzing device. Darting data of the player may be transmitted to the opponent's receiving and analyzing device via the network server, further transmitted to the opponent's dart target, and displayed or indicated on the opponent's dart target, and vice versa. In such a way, it can advance a relatively simple single-machine dart competition game to a broader network platform and facilitate exchange and comparison of darting skills among players in different regions or physical locations. As a result, the dart game may become more challenging, more interesting, and more entertaining. Through network dart competition, limitations by different regions or physical locations, and different times can be overcome or mitigated. And dart competitions can be held among various players across the world.

In the present disclosure, a network dart competition method for a network dart competition system is also provided. The method may include one or more of the following steps. Operations in the following steps are, optionally, combined or split and/or the order of some operations is, optionally, changed.

Initially, a first (e.g., player) receiving and analyzing device receives inputs from a first user (e.g., a player), and a second (e.g., opponent) receiving and analyzing device receives inputs from a second user (e.g., an opponent). The inputs from the first user may include, for example, player information and a type of game to join. The inputs from the second user may include, for example, opponent information and a type of game to join. A network dart competition may begin if the game types that the two users plan to join match.

Next, the first and/or the second user throw a dart toward a respective dart target. If a dart is received by a first dart target (e.g., hits one subzone of the first dart target), the sensor corresponding to the subzone generates an interrupt signal and transmits the interrupt signal to the first control circuit of the first dart target. The first control circuit controls the scanner to scan the dart landing region where the dart is received at the first dart target.

Next, the scanner of a controller associated with the first dart target transmits a signal representing the position of the dart landing region to a signal receiver of the first receiving and analyzing device via the first communication circuit. The signal receiver then transmits the signal to a data analyzer, which determines a score corresponding to the dart landing region.

Next, the data transmitter of the first receiving and analyzing device may provide the score to a display of the first receiving and analyzing device via the first communication circuit. If the user confirms that there is no error, the second communication circuit of the first receiving and analyzing device transmits a signal representing the score to a network server. The network server further transmits the score to a second (e.g., opponent) receiving and analyzing device, and the second receiving and analyzing device then transmits the score to the second (e.g., opponent) dart target.

Next, upon receiving the score, a second control circuit of the second (e.g., opponent) dart target controls one or more LED lights of second dart target. For example, based on the score received, LED lights associated with certain regions of the second (e.g., opponent) dart target may be turned on and LED lights associated with other regions may be turned off.

In some embodiments of the present disclosure, a network dart competition system can further include a score accumulator. The score accumulator may determine a cumulative score by, for example, increase or reduce scores every time when a dart is received at a dart target (e.g., hit). The cumulative score (e.g., the reduced score) may be displayed on a display of a receiving and analyzing device.

In some embodiments of the present disclosure, a network dart competition system can further include a counter. The counter may be associated with a dart target for counting the number of times a dart is received at the dart target. For example, every time when a dart hits the dart target, the counter counts one. And if the number recorded by the counter reaches a threshold number (e.g., N, where N is 2-10), the user may be required to press or touch a NEXT button before the user can throw the next dart.

In some embodiments, in a network dart competition system according to the present disclosure, a player's darting data can be provided to the opponent receiving and analyzing device via a network server. The opponent receiving and analyzing device may further transmit the player's darting data to the opponent dart target, which can indicate the player's darting data (e.g., by controlling the LEDs). In such a way, the network dart competition system of the present disclosure can advance a relatively simple single-machine dart fighting game to a broader network platform and facilitates exchange and comparison of darting skills among players in different regions or physical locations, such that the dart game is more challenging, more interesting, and more entertaining. Through network dart competition, limitations by different regions or physical locations and different time zones can be overcome or mitigated, and game dreams can be realized for various players.

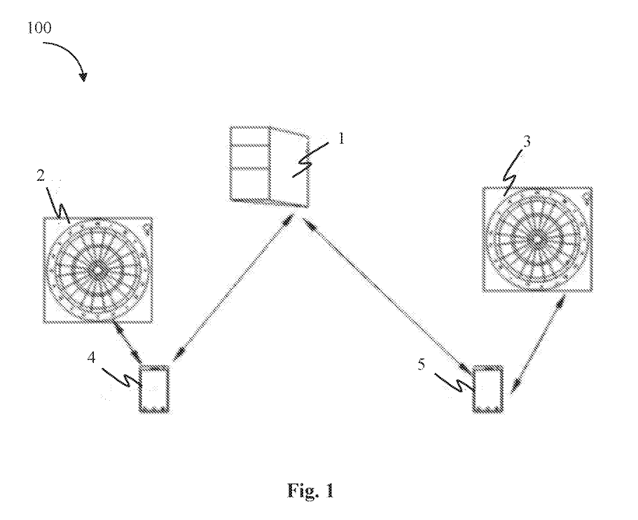

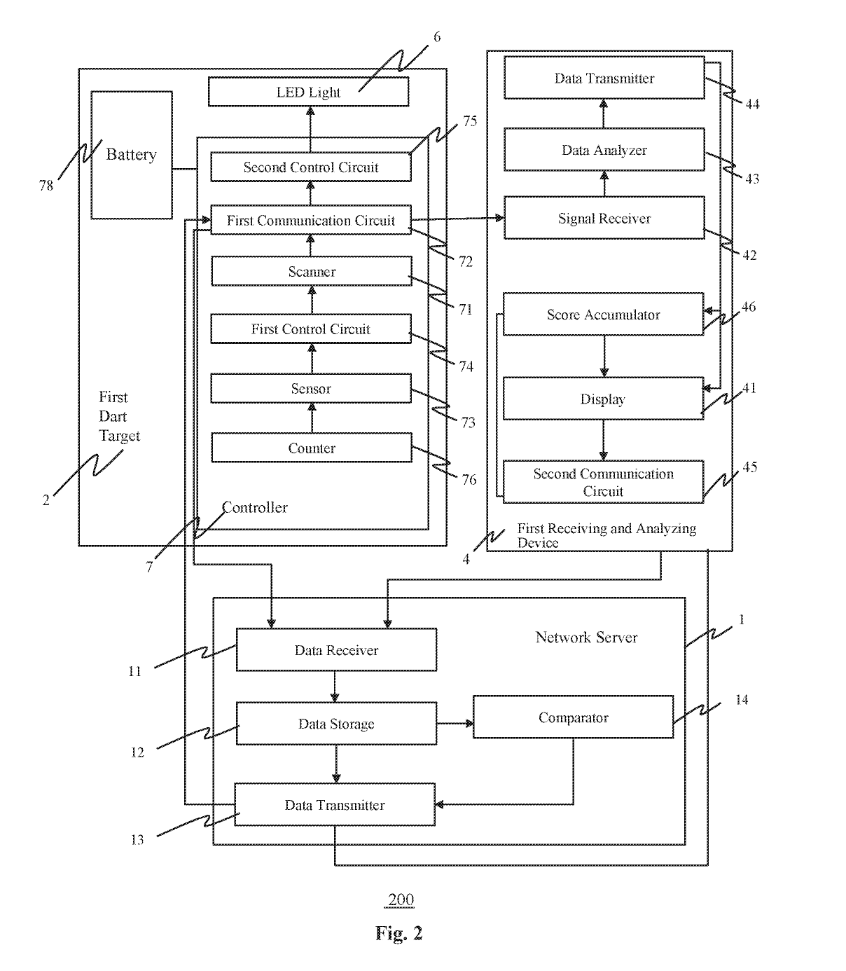

FIG. 1 is a schematic diagram illustrating a system and environment 100 for implementing network dart competition according to various examples. FIG. 2 is a block diagram 200 illustrating a receiving and analyzing device 4, a user dart target 2, and a network server 1 according to various examples.

As shown in FIG. 1 and FIG. 2, a system and environment 100 for implementing network dart competition can include one or more of: a network server 1, a first dart target 2, a second dart target 3, a first receiving and analyzing device 4, and a second receiving and analyzing device 5. The first dart target 2 may be a player dart target and the second dart target 3 may be an opponent dart target. The first receiving and analyzing device 4 may be a player receiving and analyzing device and the second receiving and analyzing device 5 may be an opponent receiving and analyzing device.

In some embodiments, one or both of the first receiving and analyzing device 4 and the second receiving and analyzing device 5 can communicate with the network server 1 via wired or wireless protocols such as the TCP/IP or Zigbee protocol. In some examples, the first dart target 2 communicates with the first receiving and analyzing device 4 via wired or wireless connections such as a Bluetooth, Wi-fi, or infrared connection. The second dart target 3 communicates with the second receiving and analyzing device 5 via wired or wireless connections such as a Bluetooth, Wi-fi, or infrared connection.

In the present disclosure, the term “player” and “opponent” are used for convenience of description. For example, there may be more than one player and more than one opponent. Moreover, locations of the players and opponents may be different. The first dart target 2 and the second dart target 3 may have the same or different structure. In a network dart competition system of the present disclosure, a player's darting data can be transmitted to the opponent receiving and analyzing device and the opponent dart target via the network server 1. And the player's darting data can be indicated or displayed on the dart target 3, and vice versa. In such a way, it can advance a relatively simple single-machine dart competition game to a broader network platform and facilitate exchange and comparison of darting skills among players in different regions, such that the dart game is more challenging, more interesting, and more entertaining. Through network competition, limitations by different regions or physical locations and different time zones can be overcome or mitigated. And dart competitions can be held among various players across the world.

As shown in FIGS. 1 and 2, in some embodiments, one or both of the first dart target 2 and the second dart target 3 can be electrically coupled with an LED light 6 and a controller 7. The controller 7 can be communicatively connected to the LED light 6. In some examples, the controller 7 may include a processor such as a micro-control unit (MCU), a general purpose processor, a CPU, and/or a FPGA. The controller 7 runs or executes various software programs and/or sets of instructions stored in a memory (not shown) to perform various functions for the dart target 2 and to process data. In some embodiments, various components (e.g., the first communication circuit 72, the scanner 71, the sensor 73, etc.) may be implemented on a single chip, such as controller 7. In some other embodiments, they may be implemented on separate chips or discrete modules/components. The memory of a dart target (e.g., the first dart target 2 or the second dart target 3) may include one or more computer-readable storage mediums. The computer-readable storage mediums may be tangible and non-transitory. The memory may include high-speed random access memory and may also include non-volatile memory, such as one or more magnetic disk storage devices, flash memory devices, or other non-volatile solid-state memory devices. The memory may be controlled by a memory controller for accessing the memory by other components of the dart target.

In some embodiments, the controller 7 can include a first communication circuit 72, a scanner 71, a first control circuit 74, a sensor 73, and a counter 76. In some examples, a first communication circuit 72 facilitates data transmission between the controller 7 of the dart target 2 and the receiving and analyzing device 4. The first communication circuit 72 can transmit data from the controller 7 of the first dart target 2 to the first receiving and analyzing device 4. The first communication circuit 72 can also receive data from the first receiving and analyzing device 4 to the controller 7 of the first dart target 2. As a result, the first communication circuit 72 can facilitate two-way data transmission. Similarly, data can be transmitted from a controller 7 of the second dart target 3 to the second receiving and analyzing device 5, and can also be transmitted from second receiving and analyzing device 5 to the controller 7 of the second dart target 3.

As shown in FIG. 2, in some embodiments, the first communication circuit 72 may include at least one of a Bluetooth interface, a Wi-fi interface, an infrared interface, or a wired communication interface.

In some embodiments, the sensor 73 can generate an interrupt signal in response to detecting the receiving of a dart (e.g., hits) at the dart target 2, and transmit the interrupt signal to a first control circuit 74. The first control circuit 74 receives the interrupt signal transmitted from the sensor 73 and controls actions of a scanner 71. For example, when the first control circuit 74 receives the interrupt signal, it can activate the scanner 71 to determine a dart landing region.

In some embodiments, the scanner 7 can scan the dart landing region where a dart is received (e.g., hits) the dart target 2, upon receiving an interrupt signal provided by the first control circuit 74. In some examples, the scanner 7 can transmit a signal representing the position of the dart landing region to the receiving and analyzing device 4 via the first communication circuit 72.

In some embodiments, the second control circuit 75 can receive a signal representing a score associated with the opposing dart target (e.g., second dart target 3 in FIG. 1). The signal can be transmitted from the network server 1, from the second dart target 3, and/or from the second receiving and analyzing device 5. The signal can be used to control switching of the LED lights 6.

In some embodiments, the dart target 2 can further include a battery 78. The battery 78 may be electrically connected to the controller 7 and the LED lights 6. The battery may be a rechargeable battery or a dry cell, and the battery can provide electrical energy to the controller 7 and the LED lights 6.

As shown in FIGS. 1 and 2, in some embodiments, one or both of the dart targets 2 and 3 may include a plurality of subzones, and one or more of the subzones are associated with antennas (not shown). In some examples, the antennas are located on the back of the subzones. Under a first condition, an antenna may be disposed above the controller 7. If a dart is received at the subzone, the antenna may be in contact with the controller 7. For example, the antenna may be pressed downwardly onto the controller 7 and be in contact with the controller 7 due to the acting force provided by the dart. In some example, each subzone may be associated with one sensor 73. As a result, if the antenna is in contact with the controller 7, the sensor 73 corresponding to the subzone generates an interrupt signal. Each subzone may also correspond to at least one LED light 6. As a result, the dart data associated with the second dart target 3 (e.g., target number that the opponent hits) may be indicated on the first dart target 2 by using the LED lights. In some example, for such indication, light color and light effect of LED lights 6 may be configured to be different, or configured to be identical.

As shown in FIG. 2, in some embodiments, the controller 7 may further includes a counter 76. The counter 76 can count the number of times a dart is received at the dart target 2. For example, the counter 76 can record the number of target hits. The counter 76 is electrically connected to the sensor 73. In some examples, if the sensor 73 transmits an interrupt signal, it indicates one target hit, and the counter 76 increases the count by one. The counter 76 may be further connected to a NEXT button (not shown). The NEXT button may be disposed on the dart target 2 and connected to the battery 78. If the number recorded by the counter 76 reaches a threshold value, the counter 76 may be re-set, and a user (e.g., player) may need to press the NEXT button before the user can throw another dart.

As shown in FIGS. 1 and 2, in some embodiments, one or both of the first receiving and analyzing device 4 and the second receiving and analyzing device 5 can include a second communication circuit 45, display 41, score accumulator 46, signal receiver 42, data analyzer 43, and data transmitter 44. In some examples, the second communication circuit 45 can facilitate data transmission between the receiving and analyzing device 4 and the network server 1. The second communication circuit 45 can transmit data from the first receiving and analyzing device 4 to the network server 1, and can also receive data from the network server 1 to the first receiving and analyzing device 4. As a result, the second communication circuit 45 can facilitate two-way data transmission. Similar, the second communication circuit 45 of the second receiving and analyzing device 5 can transmit data from the second receiving and analyzing device 5 to the network server 1, and can also receive data from the network server 1 to the second receiving and analyzing device 5.

In some examples, the second communication circuit 45 can communicate using wired or wireless protocols such as the TCP/IP or Zigbee protocol, or any other communication protocols.

As shown in FIGS. 1 and 2, the signal receiver 42 can receive a signal transmitted from the controller 7 and transmit the signal to the data analyzer 43. For example, the scanner 71 transmits a signal representing the position of the dart landing region to the signal receiver 42 via the first communication circuit 72. The signal receiver 42 further transmits the signal to the data analyzer 43. The data analyzer 43 can determine a score based on the signal representing the position of the dart landing region. For example, the data analyzer 43 can calculate a score corresponding to the dart landing region.

In some embodiments, the signal transmitter 44 can transmit the score determined by the data analyzer 43 to the network server 1. The network server 1 can then transmit the score to the second receiving and analyzing device 5 (e.g., an opponent receiving and analyzing device). In some embodiments, the signal transmitter 44 can also transmit the score directly to the second receiving and analyzing device 5 without the network server 1 through, for example, a local area connection, a Wi-Fi connection, etc.

In some embodiments, one or both of the first receiving and analyzing device 4 and the second receiving and analyzing device 5 can further include a display 41. Display 41 can display, for example, at least one of a Bluetooth connection status, a power condition, an indication of whether a subzone is interfered (e.g., long pressed by a foreign object), or an indication of whether more than one subzone are pressed simultaneously. In some examples, the display 41 is further provided with a NEXT button.

In some embodiments, one or both of the first receiving and analyzing device 4 and the second receiving and analyzing device 5 can further include a score accumulator 46. The score accumulator 46 can be connected to the signal transmitter 44. The score accumulator 46 can, for example, subtract each score from the total score until the total score becomes 0, or add each score. Score accumulator 46 can thus facilitate smart scoring and improving the entertainment of dart games.

In some embodiments, one or both of the first receiving and analyzing device 4 and the second receiving and analyzing device 5 can include at least one of at least a portion of a smart phone, a tablet computer, or a digital TV, or may be other components or devices having data transmission and reception capabilities. In some examples, a receiving and analyzing device (e.g., first receiving and analyzing device 4 and the second receiving and analyzing device 5) can include a memory (not shown). The memory of the receiving and analyzing device may include one or more computer-readable storage mediums. The computer-readable storage mediums may be tangible and non-transitory. The memory may include high-speed random access memory and may also include non-volatile memory, such as one or more magnetic disk storage devices, flash memory devices, or other non-volatile solid-state memory devices. The memory may be controlled by a memory controller for accessing the memory by other components of the receiving and analyzing device.

As shown in FIGS. 1 and 2, the network server 1 can include a data receiver 11, a data storage 12, and a data transmitter 13. In some embodiments, the data receiver 11 can receive data from the dart targets (e.g., the first data target 2) and/or the receiving and analyzing devices (e.g., the first receiving and analyzing device 4). The data storage 12 can store information received from the data receiver 11. Such information may include, for example, identity information of the users (e.g., players and opponents), hitting score information, game modes, and/or game types. The data transmitter 13 can transmit data to the dart targets and/or the receiving and analyzing devices. In some examples, the network server 1 can facilitate the data exchange between the second dart target 3 and the first dart target 2.

In some embodiments, the network server 1 can further include a comparator 14 for ranking games or users (e.g., players). The ranking information can be transmitted to the first receiving and analyzing device 4 and the second receiving and analyzing device 5 through the data transmitter 13, such that users can be timely or instantly aware of their rankings. The comparator 14 is connected to the data storage 12. In some examples, a network server (e.g., network server 1) may include a memory (not shown). The memory of the network server may include one or more computer-readable storage mediums. The computer-readable storage mediums may be tangible and non-transitory. The memory may include high-speed random access memory and may also include non-volatile memory, such as one or more magnetic disk storage devices, flash memory devices, or other non-volatile solid-state memory devices. The memory may be controlled by a memory controller for accessing the memory by other components of the network server.

In some examples, the system and environment 100 of the present disclosure can include one or more of: a network server 1, the first and second dart targets 2 and 3, and the first and second receiving and analyzing devices 4 and 5. One or both the first receiving and analyzing device 4 and the second receiving and analyzing device 5 can communicate with the network server 1. The first dart target 2 communicates with the first receiving and analyzing device 4, and the second dart target 3 communicates with the second receiving and analyzing device 5. Darting data of the first user using the first dart target 2 may be transmitted to the second receiving and analyzing device 5 via the network server 1, and further transmitted to the second dart target 3 and represented on the second dart target 3, and vice versa. In such a way, it can advance a relatively simple single-machine dart competition game to a broader network platform and facilitate exchange and comparison of darting skills among players in different regions or physical locations. As a result, the dart game may become more challenging, more interesting, and more entertaining. Through network dart competition, limitations by different regions or physical locations, and different time zones can be overcome or mitigated. And dart competitions can be held among various players across the world.

It is understood by persons of skill in the art that the functional blocks described in FIGS. 1 and 2 can be, optionally, combined or separated into sub-blocks to implement the principles of the various described embodiments. Therefore, the description herein optionally supports any possible combination or separation or further definition of the functional blocks described herein.

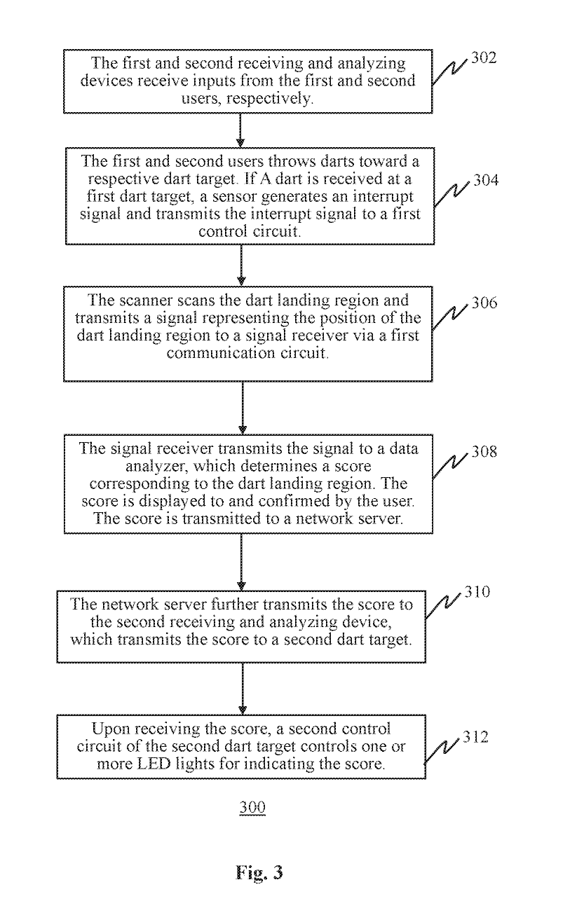

FIG. 3 illustrates a flow diagram of an exemplary network dart competition method 300 according to various examples. Method 300 may be performed using one or more of network server 1, first and second dart targets 2 and 3, and first and second receiving and analyzing devices 4 and 5, (FIGS. 1 and 2). Operations in method 300 are, optionally, combined or split and/or the order of some operations is, optionally, changed.

As shown in FIG. 3, the present disclosure further provides a network dart competition method 300 for a network dart competition system. With reference to FIG. 3, at step 302, the first (e.g., player) receiving and analyzing device (e.g., first receiving and analyzing device 4) receives inputs from a first user (e.g., a player), and a second (e.g., opponent) receiving and analyzing device (second receiving and analyzing device 5) receives inputs from a second user (e.g., an opponent). The inputs from the first user may include, for example, player information and a type of game to join. The inputs from the second user may include, for example, opponent information and a type of game to join. A network dart competition may begin if the game types that the two users plan to join match.

At step 304, the first and/or the second user throws a dart toward a respective dart target. If a dart is received by a first dart target (e.g., hits one subzone of the first dart target 2), a sensor (e.g., sensor 73) corresponding to the subzone generates an interrupt signal and transmits the interrupt signal to a first control circuit (e.g., the first control circuit 74) of the first dart target.

At step 306, the first control circuit controls a scanner (e.g., the scanner 71) to scan the dart landing region where the dart is received at the first dart target. The scanner transmits a signal representing the position of the dart landing region to a signal receiver (e.g., the signal receiver 42) via a first communication circuit (e.g., the first communication circuit 72).

At step 308, the signal receiver then transmits the signal to a data analyzer (e.g., the data analyzer 43), which determines a score corresponding to the dart landing region. A data transmitter (e.g., the data transmitter 44) provides the score to a display of the first receiving and analyzing device via the first communication circuit. If the user confirms that there is no error, a second communication circuit (e.g., the second communication circuit 45) of the first receiving and analyzing device transmits the score to a network server (e.g., the network server 1).

At step 310, the network server further transmits the score to a second receiving and analyzing device (e.g., second receiving and analyzing device 5). The second receiving and analyzing device then transmits the score to a second dart target (e.g., the second dart target 3).

At step 312, upon receiving the score, a second control circuit (e.g., the second control circuit 75) of the second dart target controls one or more LED lights (e.g., LED lights 6) of the second dart target. For example, based on the score received, LED lights associated with certain regions of the second (e.g., opponent) dart target may be turned on and LED lights associated with other regions may be turned off.

In some embodiments, a method for network competition can include one or more of the following steps. First, the first receiving and analyzing device 4 receives a player inputs including player information and a type of game to join. The second receiving and analyzing device 5 receives an opponent inputs including opponent information and a type of game to join. And a network dart competition may begin if the game types that the player and the opponent plan to join match.

Next, the player throws a dart toward a first dart target 2. If the dart is received at one subzone, the sensor 73 corresponding to the subzone generates an interrupt signal and transmits the interrupt signal to the first control circuit 74. The first control circuit 74 controls the scanner 71 to scan the dart landing region where the dart is received at the first dart target 2.

Next, the scanner 71 transmits a signal representing the position of the dart landing region to the signal receiver 42 via the first communication circuit 72. The signal receiver 42 then transmits the signal to the data analyzer 43. The data analyzer 43 determines a score corresponding to the dart landing region. The score accumulator 46 may perform a score addition or reduction to obtain a cumulative score. The cumulative score may be displayed on the display 41. In some examples, if a dart is received at the first dart target 2, the counter 76 increases the count by one. If the number recorded by the counter 76 reaches a threshold (e.g., 3), the player may be required to press the NEXT button or touch the NEXT button before the next throw can be made.

Next, the data transmitter 43 transmits the score to the display 41 of the first receiving and analyzing device 4 via the first communication circuit 72. If the player confirms that there is no error, the first receiving and analyzing device 4 transmits the score to the network server 1. The network server 1 further transmits the score to the second receiving and analyzing device 5, and the second receiving and analyzing device 5 then transmits the score to the second dart target 3.

Next, upon receiving the score, the second control circuit 75 of the second dart target 3 controls LED lights 6 of the second dart target 3. For example, based on the score received, LED lights 6 associated with certain regions of the second dart target 3 may be turned on and LED lights associated with other regions may be turned off.

The aforementioned method is described in the context of the player playing the dart competition using the first dart target. Similarly, the method can also be performed in the context of the opponent playing the competition using the second dart target. Specifically, in some embodiments, at the same time as, or before or after the player throws a dart at the first dart target 2, the second dart target 3 may receive a dart thrown by the opponent. If a dart thrown by the opponent is received at one particular subzone of the second dart target, the sensor 73 corresponding to the particular subzone generates an interrupt signal and transmits the interrupt signal to the first control circuit 74. The first control circuit 74 controls the scanner 71 to scan the dart landing region where the dart is received at the second dart target 3.

Next, the scanner 71 transmits a signal representing the position of the dart landing region to the signal receiver 42 via the first communication circuit 72. The signal receiver 42 then transmits the signal to the data analyzer 43. Data analyzer 43 of the second receiving and analyzing device 5 determines a score corresponding to the dart landing region. In some examples, the score accumulator 46 of the second receiving and analyzing device 5 performs a score addition or reduction to obtain a cumulative score. The cumulative score may be displayed on the display 41. In some examples, if a dart is received at the second dart target 3 (e.g., the opponent hits a dart), the counter 76 increases the count by one. If the number recorded by the counter 76 reaches a threshold (e.g., 3), the opponent may need to press the NEXT button or touch the NEXT button before the next throw can be made.

Next, the data transmitter 43 transmits the score to the second receiving and analyzing device 5 via the first communication circuit 72. If the opponent confirms that there is no error, the second receiving and analyzing device 5 transmits the score to the network server 1. The network server 1 further transmits the score to the first receiving and analyzing device 4. The first receiving and analyzing device 4 then transmits the score to the first dart target 2.

Next, upon receiving the score, the second control circuit 75 of the first dart target 2 controls LED lights 6 of the first dart target 2. For example, based on the score received, LED lights 6 associated with certain regions of the first dart target 2 may be turned on and LED lights associated with other regions may be turned off.

In some embodiments, the player and the opponent may throw darts at the same time or at different times. The data transmission between the player and the opponent may remain the same when the player and the opponent competes or plays at the same time or at different times. For example, the first receiving and analyzing device 4 can, substantially in real time, display the score (e.g., number of hitting darts) of the player and the score (e.g., the number of hitting darts) of the opponent. Similarly, the second receiving and analyzing device 5 can also, substantially in real time, display the score (e.g., the number of hitting darts) of the opponent and the score (e.g., the number of hitting darts) of the player. The first dart target 2 may display or indicate the dart number of the opponent, and the second dart target 3 may also display or indicate the dart number of the player. In addition, the network server 1 can further rank dart throwing of the player and the opponent, and transmit the ranking information to the first receiving and analyzing device 4 and the second receiving and analyzing device 5, such that the player and the opponent can receive their own rankings and/or rankings of others.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A network dart competition system, comprising:
a first dart target configured to receive one or more darts from a first user;
a first receiving and analyzing device communicatively connected to the first dart target;
a second dart target configured to receive one or more darts from a second user; and
a second receiving and analyzing device communicatively connected to the second dart target; wherein the first receiving and analyzing device and the second receiving and analyzing device communicate via a network to enable a dart competition between the first user and the second user.

2. The network dart competition system according to claim 1, wherein each of the first dart target and the second dart target is electrically coupled to at least one of: one or more light emitting diodes (LEDs) and a controller.

3. The network dart competition system according to claim 2, wherein the controller comprises:
one or more sensors configured to:
detect the receiving of a dart at the corresponding dart target, and
in response to detecting the receiving of the dart, generate an interrupt signal;
a first control circuit configured to control a scanner in accordance with the interrupt signal; and
the scanner configured to:
in accordance with the interrupt signal, determine a dart landing region indicating where the dart is received at the corresponding dart target, and
provide a signal representing a position of the dart landing region to the receiving and analyzing device associated with the corresponding dart target.

4. The network dart competition system according to claim 2, wherein the controller of the first dart target or the second dart target comprises:
a second control circuit configured to:
receive a signal representing a score associated with the opposing dart target, and
in accordance with the signal representing the score associated with the opposing dart target, control the status of the one or more LEDs.

5. The network dart competition system according to claim 2,
wherein the controller comprises a first communication circuit configured to facilitate data transmission between the controller and the receiving and analyzing device associated with the corresponding dart target; and
wherein each of the first receiving and analyzing device and the second receiving and analyzing device comprises a second communication circuit configured to facilitate data transmission between the corresponding receiving and analyzing device and a network server.

6. The network dart competition system according to claim 2, wherein each of the first receiving and analyzing device and the second receiving and analyzing device comprises:
a signal receiver configured to receive a signal provided by the controller, wherein the signal represents a position of a dart landing region;
a data analyzer configured to determine a score based on the signal representing the position of the dart landing region; and
a signal transmitter configured to transmit a signal representing the score to the opposing receiving and analyzing device.

7. The network dart competition system according to claim 1, further comprising a network server, wherein the network server comprises:
a data receiver configured to receive data from the at least one of the first dart target and the second dart target, or the first receiving and analyzing device and the second receiving and analyzing device;
a data storage configured to store information received from the data receiver; and
a data transmitter configured to transmit data to at least one of the first dart target and the second dart target, or the first receiving and analyzing device and the second receiving and analyzing device.

8. The network dart competition system according to claim 7, wherein the network server further comprises:
a comparator configured to rank users in a dart competition; and
the data transmitter configured to transmit the ranking information to the first receiving and analyzing device and the second receiving and analyzing device.

9. The network dart competition system according to claim 3,
wherein each of the first dart target and second dart target comprises a plurality of subzones, the backside of each of the subzones being associated with an antenna;
wherein each of the subzones is associated with a corresponding sensor being configured to:
determine whether the antenna of the subzone associated with corresponding sensor is in contact with the controller,
in accordance with a determination that the antenna of the subzone associated with corresponding sensor is in contact with the controller, generate the interrupt signal; and
wherein each subzone is associated with at least one of the LEDs.

10. The network dart competition system according to claim 3, wherein the controller further comprises a counter electrically coupled to the one or more sensors, the counter being configured to count the number of times a dart is received at the corresponding dart target.

11. The network dart competition system according to claim 2, wherein each of the first receiving and analyzing device and the second receiving and analyzing device comprises:
a display configured to display at least one of a connection status, a power condition, an indication of whether one or more subzones associated with the corresponding dart target are interfered, or a NEXT button; and
a score accumulator configured to determine a cumulative score, wherein the score accumulator is communicatively connected to the corresponding dart target.

12. The network dart competition system according to claim 1, wherein each of the first receiving and analyzing device and the second receiving and analyzing device includes at least one of a smart phone, a tablet computer, a laptop computer, a desktop computer, or a digital TV.

13. A method for network dart competition, comprising:
at a first dart target including one or more processors,
detecting the receiving of a dart at the first dart target;
in response to detecting the receiving of a dart, generating an interrupt signal;
in accordance with the interrupt signal, determining a dart landing region indicating where the dart is received at the first dart target; and
transmitting a signal representing a position of the dart landing region to a receiving and analyzing device associated with the first dart target.

14. The method according to claim 13,
wherein detecting of the receiving of a dart comprises determining whether an antenna associated with a subzone of the first dart target is in contact with a controller of the first dart target; and
wherein generating the interrupt signal comprises generating the interrupt signal in accordance with a determination that the antenna of a subzone of the first dart target is in contact with the controller of the first dart target.

15. The method according to claim 13, further comprising counting the number of times a dart is received at the first dart target.

16. The method according to claim 13, further comprising:
receiving a signal representing a score associated with a second dart target; and
in accordance with the signal representing the score associated with the second dart target, controlling the statuses of one or more light emitting diodes (LEDs), wherein the LEDs are electronically coupled to the first dart target.

17. A method for network dart competition, comprising:
at a first receiving and analyzing device including one or more processors,
receiving a signal representing a position of a dart landing region associated with a first dart target;
determining a first score based on the signal representing the position of the dart landing region associated with the first dart target; and
transmitting a signal representing the first score to a second receiving and analyzing device.

18. The method according to claim 17, further comprising, prior to transmitting the signal representing the first score to a second receiving and analyzing device:
displaying the first score; and
receiving a confirmation of the first score from a user of the first receiving and analyzing device.

19. The method according to claim 17, further comprising:
obtaining a cumulative score based on the signal representing the first score; and
displaying the cumulative score.

20. The method according to claim 17, further comprising:
receiving a signal representing a second score, wherein the second score is provided by the second receiving and analyzing device;
in accordance with the signal representing the second score, display the second score; and
transmitting a signal representing the second score to a second dart target associated with the second receiving and analyzing device, wherein statuses of one or more light emitting diodes (LEDs) are controlled based on the second score.

21. The method according to claim 17, further comprising:
receiving ranking information from a network server, wherein the ranking information is obtained based on ranking of users in a dart competition.

22. The method according to claim 17, further comprising:
displaying at least one of a connection status, a power condition, an indication of whether one or more subzones associated with the first dart target are interfered, or a NEXT button.

23. A non-transitory computer-readable storage medium comprising one or more programs for execution by one or more processors of an electronic device, the one or more programs including instructions which, when executed by the one or more processors, cause the electronic device to perform a method comprising:
receiving a signal representing a position of a dart landing region associated with a first dart target;
determining a first score based on the signal representing the position of the dart landing region associated with the first dart target; and
transmitting a signal representing the first score to a second receiving and analyzing device.

24. The computer-readable storage medium according to claim 23, further comprising instructions causing the electronic device to perform, further comprising:
obtaining a cumulative score based on the signal representing the first score; and
displaying the cumulative score.

25. The computer-readable storage medium according to claim 23, further comprising instructions causing the electronic device to perform:
receiving a signal representing a second score, wherein the second score is provided by the second receiving and analyzing device;
in accordance with the signal representing the second score, display the second score; and
transmitting a signal representing the second score to a second dart target associated with the second receiving and analyzing device, wherein statuses of one or more light emitting diodes (LEDs) are controlled based on the second score.
